(19) United States
(12) Patent Application Publication
(10) Pub. No.: US 2026/0134413 A1
(43) Pub. Date: May 14, 2026

(54) Systems Devices and Methods for Handling Off-Platter Conditions at a Scale

(71) Applicant: Zebra Technologies Corporation, Lincolnshire, IL (US)

(72) Inventors: Edward Barkan, Miller Place, NY (US); Darran Michael Handshaw, Sound Beach, NY (US); Scott Henry, Monroe, GA (US)

(21) Appl. No.: 18/947,218

(22) Filed: Nov. 14, 2024

(51) Int. Cl. G06Q 20/20

(52) U.S. Cl. CPC G06Q 20/208; G06Q 20/201

(57) ABSTRACT

The present disclosure relates to item identification and weighing devices for use with point of sale (POS) systems. In some embodiments, devices disclosed herein are configured to determine a presence or a lack of an off-platter condition during weighing operations and provide the POS system with a total price for the item being weight only in certain conditions. Namely, when an off-platter condition is present, the item identification and weighing device does not transmit the total weight of the item to the POS system, and when an off-platter condition is absent, the item identification and weighing device does transmit the total weight of the item to the POS system.

### BACKGROUND

When weighing items on a scale it is important to avoid instances where items that are being weighed are not resting fully on the weigh platter. Instances of such off-platter conditions can cause the scale to read an incorrect weight, leading to incorrect weighing results. This can be particularly important in retail settings where the scale is used determine the weight of items like produce and where the customer is charged for the items based on the item's weight. As such, there continues to be a need for improved solutions for preventing a transaction from being processed when an off-platter condition is present.

### SUMMARY

In an embodiment the present disclosure describes a system comprising: a point-of-sale (POS) terminal operable to execute a transaction associated with a purchase of an item; an item identification and weighing apparatus having: a weigh platter having a first surface extending in a first transverse plane; a scale configured to measure a weight of the item when placed on the surface; an off-platter detection assembly configured to detect an off-platter condition; an item identification module configured to identify the item; an item price computation module configured to determine a price of the item based on identity information of the item received from the item identification module, the weight of the item received from the scale, and a price-per-unit of weight of the item stored in a memory associated with the item identification and weighing apparatus; a communication interface configured to communicate with the POS terminal; a processor in communication with the scale, the off-platter detection assembly, the item identification module, the item price computation module, and the communication interface; and a non-transitory machine-readable storage medium storing instructions that, when executed by the processor, cause the item identification and weighing apparatus to: responsive to a presence the off-platter condition, preventing a transmission of the price of the item to the POS terminal; and responsive to an absence of the off-platter condition, transmitting the price of the item to the POS terminal, wherein the presence of the off-platter condition based on at least one of (i) a portion of the item resting on a second surface off the weigh platter or (ii) at least some portion of the item extending beyond a perimeter of the weigh platter, and wherein the absence of the off-platter condition is based on at least one of (i) no portion of the item resting on the second surface off the weigh platter or (ii) no portion of the item extending beyond the perimeter of the weigh platter.

In another embodiment the present disclosure describes an item identification and weighing apparatus for use with a point-of-sale (POS) terminal operable to execute a transaction associated with a purchase of an item, the item identification and weighing apparatus comprising: a weigh platter having a first surface extending in a first transverse plane; a scale configured to measure a weight of the item when placed on the surface; an off-platter detection assembly configured to detect an off-platter condition; an item identification module configured to identify the item; an item price computation module configured to determine a price of the item based on identity information of the item received from the item identification module, the weight of the item received from the scale, and a price-per-unit of weight of the item stored in a memory associated with the item identification and weighing apparatus; a communication interface configured to communicate with the POS terminal; a processor in communication with the scale, the off-platter detection assembly, the item identification module, the item price computation module, and the communication interface; and a non-transitory machine-readable storage medium storing instructions that, when executed by the processor, cause the item identification and weighing apparatus to: responsive to a presence the off-platter condition, preventing a transmission of the price of the item to the POS terminal; and responsive to an absence of the off-platter condition, transmitting the price of the item to the POS terminal, wherein the presence of the off-platter condition based on at least one of (i) a portion of the item resting on a second surface off the weigh platter or (ii) at least some portion of the item extending beyond a perimeter of the weigh platter, and wherein the absence of the off-platter condition is based on at least one of (i) no portion of the item resting on the second surface off the weigh platter or (ii) no portion of the item extending beyond the perimeter of the weigh platter.

In yet another embodiment, the present disclosure describes a method for handling off platter events at an item identification and weighing apparatus for use with a point-of-sale (POS) terminal operable to execute a transaction associated with a purchase of an item, the method comprising: identifying the item via an item identification module; determining, via a scale, a weight of the item when placed on a weigh platter of the item identification and weighing apparatus; determining, via an item price computation module, a price of the item based on identity information of the item received from the item identification module, the weight of the item received from the scale, and a price-per-unit of weight of the item stored in a memory associated with the item identification and weighing apparatus; determining, via an off-platter detection assembly, if an off-platter condition is present; responsive to a presence the off-platter condition, preventing a transmission of the price of the item to the POS terminal; and responsive to an absence of the off-platter condition, transmitting the price of the item to the POS terminal, wherein the presence of the off-platter condition based on at least one of (i) a portion of the item resting on a second surface off the weigh platter or (ii) at least some portion of the item extending beyond a perimeter of the weigh platter, and wherein the absence of the off-platter condition is based on at least one of (i) no portion of the item resting on the second surface off the weigh platter or (ii) no portion of the item extending beyond the perimeter of the weigh platter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed examples, and explain various principles and advantages of those embodiments.

FIG. 1 illustrates an example item identification and weighing apparatus, in accordance with aspects of described embodiments.

FIGS. 2 and 3 illustrate example flowcharts representative of various embodiments of operating the example item identification and weighing apparatus of FIG. 1.

FIG. 4 is a block diagram of an example logic circuit to implement the example methods, apparatus, logic and/or operations described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure generally relates to checkout workstations having off-platter detection systems that can be used to detect instances of off-platter conditions, in which at least a portion of an item to be purchased is not resting on the weighing platter of the checkout workstation.

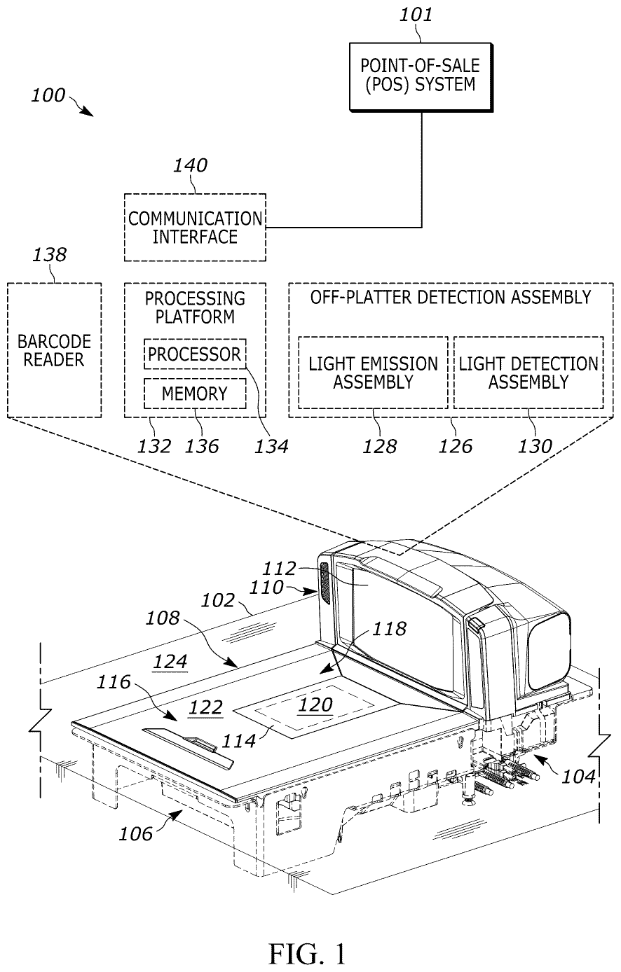

Referring to FIG. 1, shown therein is an example item identification and weighing apparatus 100, such as the Zebra® MP7000 bioptic barcode reader. The item identification and weighing apparatus 100 is configured to manage price computation and selective data transmission to provide price data to a point-of-sale (POS) system 101 (also referred to as a POS terminal), particularly in case of items where the cost is calculated based on price-per-unit of weight of the item. The POS terminal 101 is a terminal that is commonly used in retail venues such as grocery stores and is often operated either by cashiers or by customers via self-checkout kiosk/workstation. The POS terminal 101 is configured to execute transactions based on pricing information it receives and in various embodiments it does not calculate item price based on transmitted weight data. Instead, it relies on the item identification and weighing apparatus 100 to calculate the item price and selectively transmit this price depending on the item's positioning on the weigh platter. This design minimizes reliance on the POS terminal for accurate transaction processing, as the computational duties for price calculation.

The exemplary POS terminal 101 typically includes components like a user interface, a processor, and a memory. The user interface can include a display for visually displaying information to a user and some type of a user input device like a keyboard or a touch-enabled display. The interface may be used by the cashier or operator of the POS terminal to process transaction and to keep track of items that have been or are in the process of being scanned in connection with each transaction. The POS terminal 101 commonly interfaces with third-party payment systems-related components which further enable operators to pay for items being purchased.

Transitioning to the item identification and weighing apparatus 100, it can be configured to be physically supported by a workstation 102, such as a checkout counter at a POS workstation of a retail store. The item identification and weighing apparatus 100 has an example housing 104 that includes an example lower housing 106 that houses an example weigh platter assembly 108, and an example upper housing 110 that extends generally perpendicular to the lower housing 106. The upper housing 110 includes an example generally vertical window 112 to allow a first set of optical components positioned within the upper housing 110 to form a first field-of-view (FOV) through the vertical window 112. In addition, if the item identification and weighing apparatus 100 is a bioptic barcode scanner, the lower housing 106 will include a generally horizontal window 114, which is positioned in a weigh platter 116 of the weigh platter assembly 108 to allow a second set of optical components positioned within lower housing 106 to form a second FOV through the horizontal window 114. The first FOV and second FOV intersect to define a product scanning region 118 of the item identification and weighing apparatus 100 where a product can be scanned for sale at the POS.

Although the weigh platter assembly 108 can be used with a barcode scanner or bioptic barcode reader, the weigh platter assembly 108 can be used with any type of scanner, reader or POS system 101, or can be used as a stand-alone scale or weighing device. Whether used as part of a barcode reader, scanner or POS system 101, or as a stand-alone scale or weighing device, the weigh platter assembly 108 will generally include the weigh platter 116 and an example scale 120 configured to measure the weight of an object placed on a surface 122 of the weigh platter 116. The surface 122 extends in a first transverse plane and is generally or substantially parallel to an example top surface 124 of the workstation 102 that at least partially surrounds the weigh platter 116.

To detect an off-platter weigh condition, the item identification and weighing apparatus 100 includes an example off-platter detection assembly 126. The off-platter detection assembly 126 includes an example light emission assembly 128, and an example light detection assembly 130. An example processing platform 132 is in communication with the light emission assembly 128 and the light detection assembly 130 and/or, more generally, the off-platter detection assembly 126. The processor platform 132 is in communication with a light source (not shown for clarity of illustration) of the light emission assembly 128, and with a light sensor (not shown for clarity of illustration) of the light detection assembly 130. If the light source of the light emission assembly 128 is configured by the processing platform 132 to emit light (e.g., one or more pulses of light), the processing platform 132 can process light detection information captured by the light detection assembly 130 to detect when a portion of an item, object, etc. is resting on a surface other than the surface 122 of the weigh platter 116 (e.g., on the top surface 124 of the workstation 102) as an off-platter weigh condition, extends beyond edge of weigh platter 116, etc. For simplicity, only a single light emission assembly 128 and only a single light detection assembly 130 are shown and described herein, however, it will be understood that off-platter detection assembly 126 can also include any number and/or type(s) of light emission assemblies, and any number and/or type(s) light detection assemblies may be implemented to detect off-platter weigh condition on different sides of the weigh platter 116.

Additionally, the example processing platform 132 may have therein an item price computation module which is used to calculate a total price of an item being weighed where that price is based on a price-per-unit of weight of the item. For example, if apples having a price of $2.00 per pound are weighed and the item identification and weighing apparatus 100 determines that there the total weight of the apples placed on the platter is three pounds, then the item price computation module would determine that the total price for the apples is $6.00. This can be done in a variety of ways and requires access to item identification data and the price-per-unit of weight data.

The item identification data can be determined by another module - which can be implemented as part of the processing platform 132 - and can include various means for identifying the item placed on the platter. For example, the item identification module may rely on image data captured by the imaging components of the item identification and weighing apparatus 100 where the module, either on its own or with assistance from other systems, performs various machine vision processes to determine the identify of the item. This can be done based on color/texture/contour/shape/and other vision-based detection modalities. The item identification module may rely on barcode data decoded from the images captured by the vision components of the apparatus 100. In many cases items placed on the platter for weighing will have a label bearing a barcode attached thereto. Operators of the apparatus 100 can scan the barcode to extract the payload which includes item-identifying data. In other instances, a user interface associated with the apparatus 100 can be used to enter data regarding the item being weighed. This can include, but is not limited to, entering of an item code, selection of an item from a choice of items presented which can further be based purely on user input or can be a selection from a narrow set of items where the apparatus 100 had identified a group of potentially matching items, and any combination thereof.

To accurately determine the total price, the apparatus 100 should also be in possession of the price-per-unit of weight of the identified item. This information can too be obtained in a variety of ways. Nonlimiting examples of this include a storing of a database of prices for various items in the memory (like the memory 136) of the apparatus 100 whereby the apparatus 100 is able to lookup the price for the identified item within the database and then output a total for the items being weighed. This database can be manually or automatically updated and can be done through direct or network connectivity means. In another example, the item identification data can be used as part of a query send to the POS terminal to receive a price of the item. Thus, once the apparatus 100 determines the specifics of the item placed on the platter, this information can be sent to the POS terminal with a request for a price-per-unit of weight. This information can be sent back from the POS terminal to the apparatus 100, allowing the item price computation module to determine the total price. In another example, the query made me made to a database residing outside of the apparatus 100 and the POS terminal 101 where a query is sent in a similar manner as described above to retrieve a price-per-unit of weight of a particular item. This information can again be used to determine the total price. It's worth pointing out that in instances where a query has to be made to a database outside of the apparatus 100, the data received from the outside database will have to be stored in the local memory of the apparatus 100. This can either be temporary such that it is only retained for purposes of computing the total price and is discarded after, it can be retained for a predetermined period of time, or it can be retained until a manual request to remove the data is made.

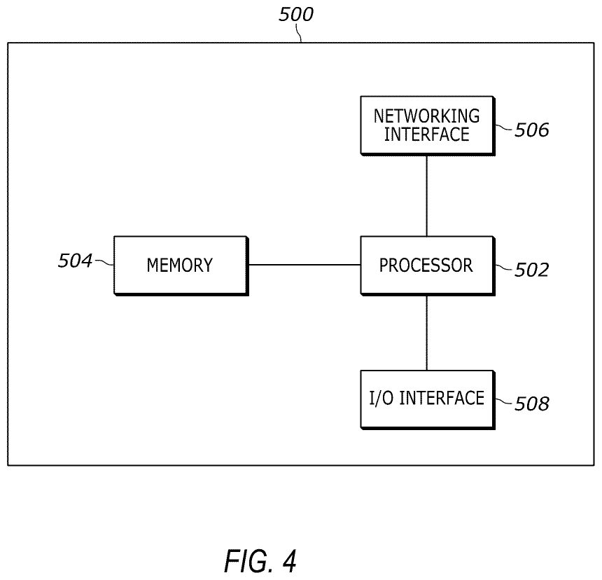

The example processing platform 132 includes a processor 134 such as programmable processor, a programmable controller, a graphics processing unit (GPU), a digital signal processor (DSP), etc. Alternatively, an application specific integrated circuit (ASIC), a programmable logic device (PLD), a field programmable gate array (FPGA), a field programmable logic device (FPLD), a logic circuit, etc. may be structured or configured to implement the processing platform 132 and/or the processor 134. The processor platform 132 includes memory 136 to store software, logic, and/or machine-readable instructions that may be executed by the processor 134. Example memory 136 includes any number or type(s) of non-transitory machine-readable storage medium or disk, such as a hard disk drive (HDD), an optical storage drive, a solid-state storage device, a solid-state drive (SSD), a read-only memory (ROM), a random-access memory (RAM), a compact disc (CD), a compact disc read-only memory (CD-ROM), a digital versatile disk (DVD), a Blu-ray disk, a cache, a flash memory, or any other storage device or storage disk in which information may be stored for any duration (e.g., permanently, for an extended time period, for a brief instance, for temporarily buffering, for caching of the information, etc.). The processing platform 500 shown in FIG. 4 may be used to implement the processing platform 132.

To read, capture, scan, etc. machine-readable codes in the form of numbers and/or a pattern of parallel lines of varying widths, printed on and identifying a product (e.g., a barcode), the item identification and weighing apparatus 100 includes a barcode reader 138, a scanner, etc. Barcodes read by the barcode reader 138 are provided to the processing platform 132.

To communicatively couple the item identification and weighing apparatus 100 to other systems, such as the POS system 101, the item identification and weighing apparatus 100 includes one or more communication interfaces, one of which is designated at reference numeral 140. The processing platform 132 can communicate with other systems, such as a POS system 101, via the communication interface 140. The communication interface 140 may communicate with the POS system 101 wirelessly, and/or via a cable communicatively coupling the item identification and weighing apparatus 100 and the POS system 101.

The foregoing system and components can be used effectively manage the transmission of data between the item identification and weighing apparatus 100 and the POS terminal 101, particularly in the events of a presence or absence of off-platter conditions. Specifically, the apparatus 100 may be configured such that responsive to a presence the off-platter condition, the apparatus is prevented from transmitting the total price of the item to the POS terminal, and responsive to an absence of the off-platter condition, the apparatus transmits the total price of the item to the POS terminal.

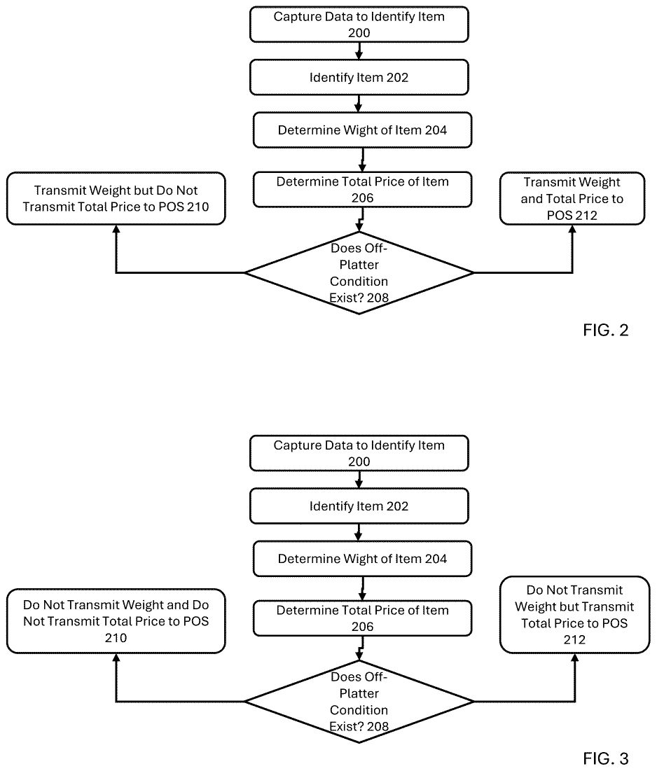

FIGS. 2 and 3 provide an exemplary flowchart representative of this functionality. Both charts remain the same until steps 210 and 212 and thus the contents of the steps as described below apply to both figures. The process begins with step 200 where the item identification and weighing apparatus captures relevant data regarding the item to be able to determine its identity. As described above, this could be based on image data, user input, a combination thereof, or other means used in the industry. This data is passed to the item identification module and the identify of the item is determined in step 202. It's worth pointing out that the reference to determining an identity does not have to result in the identification of the item as the operator would see it. Instead, the identification needs to be sufficient enough for a subsequent correlation with a price database to determine a total price. For example, if apples are being weighed and these apples include a product lookup code of 1234, the identification module may but does need to identify the items as “apples.” Instead, the identification module needs to determine an identifier (like the PLU code) associated with the item that's presented such that this identifier can be used in a subsequent query to determine a price-per-unit of weight of the item based on the identifier. Thus, the code 1234 will be sufficient for the apparatus to subsequently query the database to determine the price-per-unit of weight of the item having the code 1234, which so happen to be apples. Accordingly, this, and other similar approaches, should be seen as being within the scope of item identification, as described in this disclosure.

Besides identifying the item, the process also determines the weight of the item in step 204. This can be done in accordance with the approaches described previously in this disclosure of using a scale and a weight platter. Once both the weight and the item identity have been determined, the method includes a step 206 of determining the total price for the item being weighed. As described previously, the identify of the item is used to look up the price-per-unit of weight of the item and this times the weight of the item leads to the total price of the item being weighed.

Additionally, the method includes the step 208 of determining if an off-platter condition exists. This can be done in several ways. In some cases, there may be an explicit determination of the presence or a lack of the off-platter event. Accordingly, with every weighing event there may be a flag or some notifier sent in response to the evaluation of the off-platter detection assembly. In some cases, the apparatus 100 may assume that no-off-platter condition is the default condition and may always issue such a determination unless a position identification of the off-platter even has occurred. On the other side of this, in some cases, the apparatus may assume a constant presence of an off-platter condition and issue a flag or a notifier to the contrary when no off-platter even during the weighing is detected.

In response to the determination made in step 208, the apparatus can do one of operations. With reference to the method of FIG. 2, when an off-platter condition is preset, the method proceeds to step 210 where the weight is transmitted to the POS terminal, but the total price is not transmitted. On the other hand, if the off-platter condition does not exist, both the weight and the price are transmitted. It should be apparent in this case that it is preferred to have the POS terminal be configured in a way where, despite receiving the weight of the item, this is either disregarded or is seen as insufficient to accurately add the item to the register log. An alternate approach to this is described in FIG. 3 where rather than transmitting the price regardless of the presence or lack of an off-platter event, the apparatus 100 does not transmit the weight of the item regardless of the presence or lack of an off-platter event.

It should be appreciated that while the flowcharts of FIGS. 2 and 3 have been presented with a certain process flow, this exact flow is not necessary to remain within the scope of the claimed invention unless expressly identified. For example, the weight of the item may be determined before the determining the identify of the item. Similarly, the determination of the presence or lack of the off-platter condition does not necessarily have to occur after the determination of the total price. Instead, the chronological order of steps can be varied so long as the response to the presence or lack of an off-platter event ultimately leads either to step 210 or 212.

The processes, methods, logic, software and instructions of FIGS. 3 and 4 may be an executable program or portion of an executable program for execution by a processor such as the processor 502 of FIG. 5. The program may be embodied in software or instructions stored on a non-transitory machine- or machine-readable storage device, storage medium and/or storage disk such as a memory, a CD, a compact disc read-only memory CD-ROM, a hard drive, an SSD, a DVD, a Blu-ray disk, a cache, a flash memory, a ROM, a RAM, or any other storage device, medium or storage disk associated with the processor 502 in which information is stored for any duration (e.g., for extended time periods, permanently, for brief instances, for temporarily buffering, and/or for caching of the information). Further, although example programs are described with reference to the flowchart 300 illustrated in FIG. 3 and the flowchart 400 illustrated in FIG. 4, many other methods of implementing the barcode reading and weighing apparatus 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., discrete and/or integrated analog and/or digital circuitry, an ASIC, a PLD, an FPGA, an FPLD, a logic circuit, hardware logic, hardware implemented state machines, etc.) structured to perform the corresponding operation without executing software or instructions.

FIG. 5 is a block diagram representative of an example logic circuit capable of implementing, for example, one or more components of the example processing platform 132 and/or, more generally, the barcode reading and weighing apparatus 100 of FIG. 1. The example logic circuit of FIG. 5 is a processing platform 500 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 500 of FIG. 5 includes a processor 502 such as, for example, one or more microprocessors, controllers, and/or any suitable type of processor. The example processing platform 500 of FIG. 5 includes memory (e.g., volatile memory, non-volatile memory) 504 accessible by the processor 502 (e.g., via a memory controller). The example processor 502 interacts with the memory 504 to obtain, for example, machine-readable instructions stored in the memory 504 corresponding to, for example, the operations represented by the flowcharts of this disclosure. Additionally or alternatively, machine-readable instructions corresponding to the example operations described herein may be stored on one or more removable media (e.g., a CD, a DVD, removable flash memory, etc.) that may be coupled to the processing platform 500 to provide access to the machine-readable instructions stored thereon.

The example processing platform 500 of FIG. 5 also includes a network interface 506 to enable communication with other machines via, for example, one or more networks. The example network interface 506 includes any suitable type of communication interface(s) (e.g., wired and/or wireless interfaces) configured to operate in accordance with any suitable protocol(s). The network interface 506 may be used to implement the communication interface 140.

The example, processing platform 500 of FIG. 4 also includes input/output (I/O) interfaces 508 to obtain weights from the scale 120, obtain off-platter weigh condition indications, interact (e.g., control and receive data from) with barcode reader 138, interact the off-platter detection assembly 126, interact with the light emission assembly 128, interact the light detection assembly 130, to interact with the POS system 101, to enable receipt of user input and communication of output data to the user, etc. The I/O interfaces 508 may be used to implement the communication interface 140.

Although FIG. 5 depicts the I/O interfaces 508 as a single block, the I/O interfaces 508 may include a number of different types of I/O circuits or components that enable the processor 502 to communicate with peripheral I/O devices. Example I/O interfaces 508 include a universal serial bus (USB), a Bluetooth® interface, a near field communication (NFC) interface, and/or a PCI Express interface. The peripheral I/O devices may be any desired type of I/O device such as a keyboard, a display (a liquid crystal display (LCD), a cathode ray tube (CRT) display, a light emitting diode (LED) display, an organic light emitting diode (OLED) display, an in-place switching (IPS) display, a touch screen, etc.), a navigation device (a mouse, a trackball, a capacitive touch pad, a joystick, etc.), a speaker, a microphone, a printer, a button, a communication interface, an antenna, etc.

The embodiments disclosed herein can be particularly advantageous in that a POS system may be caused to ignore a potentially inaccurate weight without having to report a weight that is different than the weight actually recorded by the weight platter and scale. Thus, the methods and apparatuses disclosed herein may be advantageously practiced even in the presence of regulations regarding the reporting of weights.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system comprising:
a point-of-sale (POS) terminal operable to execute a transaction associated with a purchase of an item;
an item identification and weighing apparatus having:
a weigh platter having a first surface extending in a first transverse plane;
a scale configured to measure a weight of the item when placed on the surface;
an off-platter detection assembly configured to detect an off-platter condition;
an item identification module configured to identify the item;
an item price computation module configured to determine a price of the item based on identity information of the item received from the item identification module, the weight of the item received from the scale, and a price-per-unit of weight of the item stored in a memory associated with the item identification and weighing apparatus;
a communication interface configured to communicate with the POS terminal;
a processor in communication with the scale, the off-platter detection assembly, the item identification module, the item price computation module, and the communication interface; and
a non-transitory machine-readable storage medium storing instructions that, when executed by the processor, cause the item identification and weighing apparatus to:
responsive to a presence the off-platter condition, preventing a transmission of the price of the item to the POS terminal; and
responsive to an absence of the off-platter condition, transmitting the price of the item to the POS terminal,
wherein the presence of the off-platter condition based on at least one of (i) a portion of the item resting on a second surface off the weigh platter or (ii) at least some portion of the item extending beyond a perimeter of the weigh platter, and
wherein the absence of the off-platter condition is based on at least one of (i) no portion of the item resting on the second surface off the weigh platter or (ii) no portion of the item extending beyond the perimeter of the weigh platter.

2. The system of claim 1, wherein one of: (i) the weight of the item is transmitted to the POS terminal regardless of the presence of the off-platter condition or the absence of the off-platter condition; or (ii) the weight of the item is prevented from being transmitted to the POS terminal regardless of the presence of the off-platter condition or the absence of the off-platter condition.

3. The system of claim 1, wherein the item price computation module resides locally on the item identification and weighing apparatus.

4. The system of claim 1, wherein the POS terminal is not configured to calculate the price of the item.

5. The system of claim 1, wherein the item identification module includes a barcode reader, and wherein identifying the item is based on the payload of a barcode attached to the item.

6. The system of claim 1, wherein the item identification module includes a user interface, and wherein identifying the item is based on input provided by a user via the user interface.

7. The system of claim 1, wherein the item identification module includes a vision camera, and wherein identifying the item is based vision analysis of image data captured by the vision camera, the vision analysis including operations other than barcode decoding.

8. An item identification and weighing apparatus for use with a point-of-sale (POS) terminal operable to execute a transaction associated with a purchase of an item, the item identification and weighing apparatus comprising:
a weigh platter having a first surface extending in a first transverse plane;
a scale configured to measure a weight of the item when placed on the surface;
an off-platter detection assembly configured to detect an off-platter condition;
an item identification module configured to identify the item;
an item price computation module configured to determine a price of the item based on identity information of the item received from the item identification module, the weight of the item received from the scale, and a price-per-unit of weight of the item stored in a memory associated with the item identification and weighing apparatus;
a communication interface configured to communicate with the POS terminal;
a processor in communication with the scale, the off-platter detection assembly, the item identification module, the item price computation module, and the communication interface; and
a non-transitory machine-readable storage medium storing instructions that, when executed by the processor, cause the item identification and weighing apparatus to:
responsive to a presence the off-platter condition, preventing a transmission of the price of the item to the POS terminal; and
responsive to an absence of the off-platter condition, transmitting the price of the item to the POS terminal,
wherein the presence of the off-platter condition based on at least one of (i) a portion of the item resting on a second surface off the weigh platter or (ii) at least some portion of the item extending beyond a perimeter of the weigh platter, and
wherein the absence of the off-platter condition is based on at least one of (i) no portion of the item resting on the second surface off the weigh platter or (ii) no portion of the item extending beyond the perimeter of the weigh platter.

9. The item identification and weighing apparatus of claim 8, wherein one of: (i) the weight of the item is transmitted to the POS terminal regardless of the presence of the off-platter condition or the absence of the off-platter condition; or (ii) the weight of the item is prevented from being transmitted to the POS terminal regardless of the presence of the off-platter condition or the absence of the off-platter condition.

10. The item identification and weighing apparatus of claim 8, wherein the item price computation module resides locally on the item identification and weighing apparatus.

11. The item identification and weighing apparatus of claim 8, wherein the POS terminal is not configured to calculate the price of the item.

12. The item identification and weighing apparatus of claim 8, wherein the item identification module includes a barcode reader, and wherein identifying the item is based on the payload of a barcode attached to the item.

13. The item identification and weighing apparatus of claim 8, wherein the item identification module includes a user interface, and wherein identifying the item is based on input provided by a user via the user interface.

14. The item identification and weighing apparatus of claim 8, wherein the item identification module includes a vision camera, and wherein identifying the item is based vision analysis of image data captured by the vision camera, the vision analysis including operations other than barcode decoding.

15. A method for handling off platter events at an item identification and weighing apparatus for use with a point-of-sale (POS) terminal operable to execute a transaction associated with a purchase of an item, the method comprising:
identifying the item via an item identification module;
determining, via a scale, a weight of the item when placed on a weigh platter of the item identification and weighing apparatus;
determining, via an item price computation module, a price of the item based on identity information of the item received from the item identification module, the weight of the item received from the scale, and a price-per-unit of weight of the item stored in a memory associated with the item identification and weighing apparatus;
determining, via an off-platter detection assembly, if an off-platter condition is present;
responsive to a presence the off-platter condition, preventing a transmission of the price of the item to the POS terminal; and
responsive to an absence of the off-platter condition, transmitting the price of the item to the POS terminal,
wherein the presence of the off-platter condition based on at least one of (i) a portion of the item resting on a second surface off the weigh platter or (ii) at least some portion of the item extending beyond a perimeter of the weigh platter, and
wherein the absence of the off-platter condition is based on at least one of (i) no portion of the item resting on the second surface off the weigh platter or (ii) no portion of the item extending beyond the perimeter of the weigh platter.

16. The method of claim 15, wherein one of: (i) the weight of the item is transmitted to the POS terminal regardless of the presence of the off-platter condition or the absence of the off-platter condition; or (ii) the weight of the item is prevented from being transmitted to the POS terminal regardless of the presence of the off-platter condition or the absence of the off-platter condition

17. The method of claim 15, wherein the item price computation module resides locally on the item identification and weighing apparatus.

18. The method of claim 15, wherein the POS terminal is not configured to calculate the price of the item.

19. The method of claim 15, wherein the item identification module includes a barcode reader, and wherein identifying the item is based on the payload of a barcode attached to the item.

20. The method of claim 15, wherein the item identification module includes a user interface, and wherein identifying the item is based on input provided by a user via the user interface.

21. The method of claim 15, wherein the item identification module includes a vision camera, and wherein identifying the item is based vision analysis of image data captured by the vision camera, the vision analysis including operations other than barcode decoding.
